(19) United States
(12) Patent Application Publication
(10) Pub. No.: US 2011/0183744 A1
(43) Pub. Date: Jul. 28, 2011

(54) METHOD OF GAMING, A GAMING SYSTEM AND A GAME CONTROLLER

(75) Inventor: David Anthony Restuccia, Epping (AU)

(73) Assignee: Aristocrat Technologies Australia PTY Limited, North Ryde (AU)

(21) Appl. No.: 13/015,292

(22) Filed: Jan. 27, 2011

(30) Foreign Application Priority Data
Jan. 27, 2010 (AU) 2010900319

(51) Int. Cl. A63F 9/24; A63F 13/08

(52) U.S. Cl. 463/24; 463/42; 463/46

(57) ABSTRACT

Certain examples provide systems, methods, and apparatus for gaming. An example method includes initiating a wagering game comprising an initial expected time duration at which the wagering game will terminate if no time duration altering events occur in the wagering game; altering the time duration of the wagering game in response to a duration altering event occurring in the wagering game to derive a current expected time duration; and terminating the wagering game when the initial or current expected time duration expires.

### CROSS REFERENCE TO RELATED APPLICATIONS

The present application relates to and claims the benefit of priority from Australian Provisional Patent Application Number 2010900319, filed on Jan. 27, 2010, which is herein incorporated by reference in its entirety.

### FIELD

The present invention relates to a method of gaming, a gaming system and a game controller.

### BACKGROUND

Current electronic gaming machines allow a player to play a wagering game having a number of game rounds and it is known that the number of game rounds remaining may be extended in response to an event occurring in a played game round. For example, a “free spin” event may occur in a game round to extend the number of game rounds remaining in the wagering game.

While such gaming systems provide players with enjoyment, a need exists for alternative gaming systems in order to maintain or increase player enjoyment.

### SUMMARY

In a first aspect, the present invention provides a method of gaming including:

initiating a wagering game including an initial expected time duration at which the wagering game will terminate if no time duration altering events occur in the wagering game;

altering the time duration of the wagering game in response to a duration altering event occurring in the wagering game to derive a current expected time duration; and

terminating the wagering game when the initial or current expected time duration expires.

In an embodiment, the method further includes altering the initial or current expected time duration of the wagering game by truncating the initial or current expected time duration in response to a truncate event occurring in the wagering game.

In an embodiment, the method further includes altering the initial or current expected time duration of the wagering game by extending the initial or current expected time duration in response to a extend event occurring in the wagering game.

In an embodiment, the method further includes allocating a truncating duration to truncate the initial or current expected time duration of the wagering game thereby in response to the truncate event occurring in the wagering game.

In an embodiment, the method further includes allocating an extending duration to extend the initial or current expected time duration of the wagering game thereby in response to the extend event occurring in the wagering game.

In an embodiment, the method further includes allocating a maximum time duration for the current expected time duration of the wagering game.

In an embodiment, the method further includes awarding a prize to a player of the wagering game when the initial or current expected time duration expires.

In an embodiment, the method further includes allocating a value of the prize based on the initial or current expected time duration of the wagering game.

In an embodiment, the wagering game is a bonus game.

In an embodiment, the method further includes initiating the wagering game by displaying an object to a player of the wagering game on a display, whereby the object travels across the display for the initial or current expected time duration with a displayed rate of travel and distance of travel which reduces iteratively until reaching a threshold value at expiry of the initial or current expected time duration.

In an embodiment, the method further includes altering the displayed rate of travel and distance of travel by further reducing the displayed rate of travel and distance of travel of the object across the display thereby truncating the initial or current expected time duration in response to a truncate event occurring in the wagering game.

In an embodiment, the method further includes altering the displayed rate of travel and distance of travel by extending the reducing displayed rate of travel and distance of travel of the object across the display thereby extending the initial or current expected time duration in response to an extend event occurring in the wagering game.

In a second aspect, the invention provides a game controller arranged to:

initiate a wagering game including an initial expected time duration at which the wagering game will terminate if no time duration altering events occur in the wagering game;

alter the time duration of the wagering game in response to a duration altering event occurring in the wagering game to derive a current expected time duration; and

terminate the wagering game when the initial or current expected time duration expires.

In a third aspect, the invention provides a gaming system including:

a display for displaying a wagering game to a player; and

a game controller arranged to:
initiate a wagering game including an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

In a fourth aspect, the invention provides a gaming system including:

a plurality of gaming devices; and

a game controller in data communication with the plurality of gaming devices, the game controller arranged to:
initiate a wagering game including an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

In a fifth aspect, the invention provides a gaming system including:

at least one gaming device including a cabinet, a display mounted within the cabinet arranged to display a wagering game to a player, and a game play mechanism mounted to the cabinet incorporating at least one input device, the game play mechanism operable by the player to place wagers in the wagering game, and a game controller disposed within the cabinet including a processor and a memory storing game control instructions which enable the game controller to operate, the game controller arranged to:
initiate the wagering game including an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

In a sixth aspect, the invention provides a gaming system including:

means for initiating a wagering game including an initial expected time duration at which the wagering game will terminate if no time duration altering events occur in the wagering game;

means for altering the time duration of the wagering game in response to a duration altering event occurring in the wagering game to derive a current expected time duration; and

means for terminating the wagering game when the initial or current expected time duration expires

In a seventh aspect, the invention provides computer program code which when executed implements the above method.

In an eighth aspect, the invention provides a computer readable medium including the above program code.

In a ninth aspect, the invention extends to transmitting or receiving the above program code.

In a tenth aspect, the invention provides a data signal including the above program code.

### BRIEF DESCRIPTION OF DRAWINGS

Certain exemplary embodiments of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system;

FIG. 7 is a flow chart of a method of an embodiment;

FIG. 8 is a flow chart of an example of an embodiment; and

FIGS. 9a to 9c show exemplary displays of examples of embodiments.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Referring to the drawings, there is shown a method and a gaming system for implementing the method. In an embodiment, the method includes initiating a wagering game including an initial expected time duration at which the wagering game will terminate if no time duration altering events occur in the wagering game, altering the time duration of the wagering game in response to a duration altering event occurring in the wagering game to derive a current expected time duration, and terminating the wagering game when the initial or current expected time duration expires.

### General Construction of Gaming System

The gaming system can take a number of different forms. In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

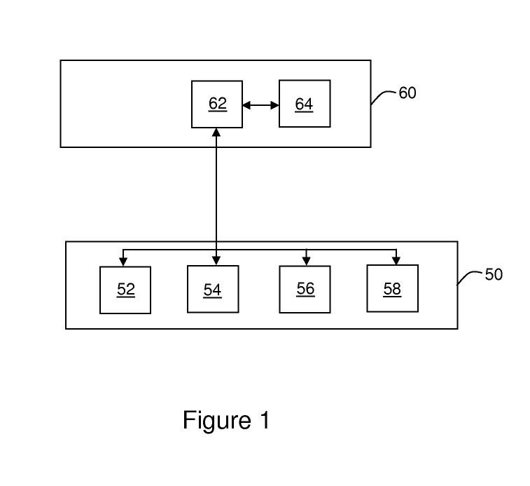

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g., to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

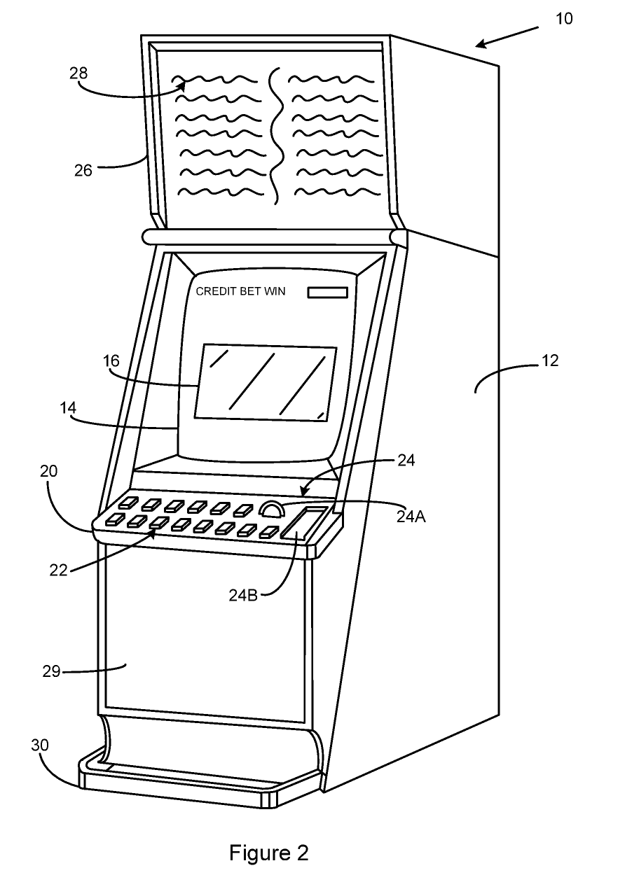

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

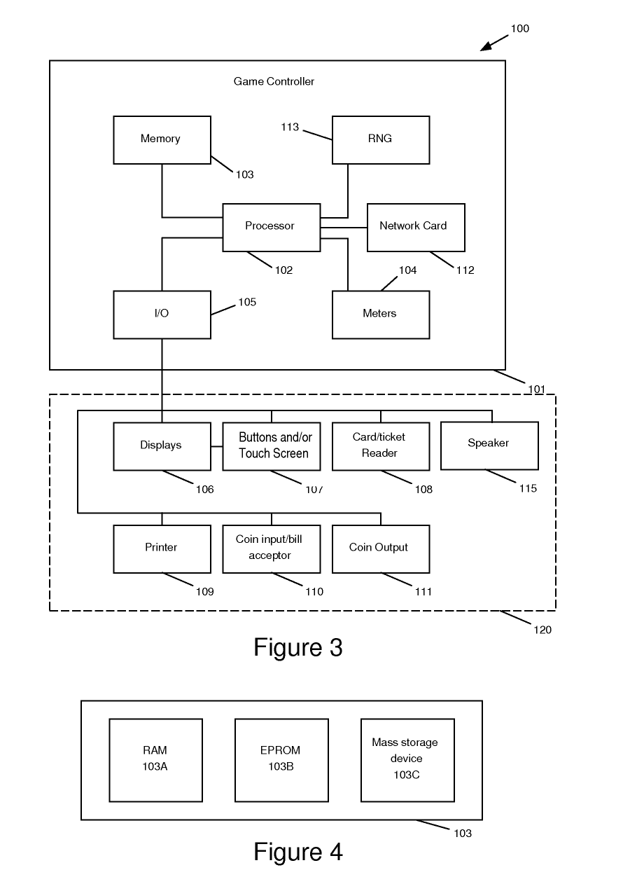

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted based on the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—e.g., the player marketing module may be in data communication with one or more of the above devices and communicate with it on behalf of the gaming machine.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

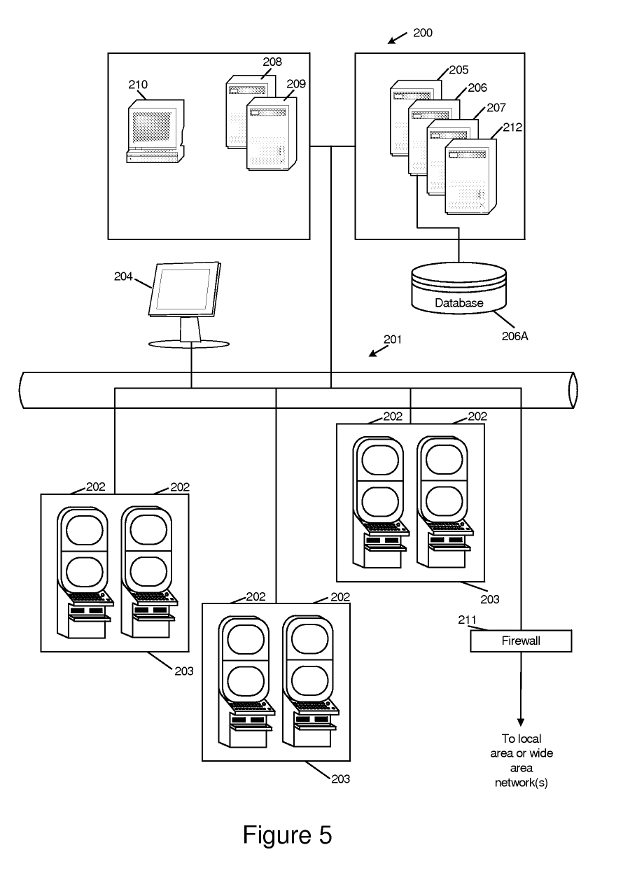

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements, rules, guidelines, and/or preferences for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g., PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of Gaming System

In an embodiment, a player operates the game play mechanism 56 to input a wager for a wagering game, or bet a number of credits for the wagering game, and input instructions (e.g. selections) for the game. The inputted instructions and wager may then be used to initiate the wagering game.

In an embodiment, the wagering game is implemented as a jackpot or bonus game that is triggered from a base game upon occurrence of corresponding trigger criteria in the base game, such as the occurrence of designated symbols in designated symbol display positions in the base game, and subsequently initiated. For example, the base game may be a spinning reel type game, where the player inputs a wager and instructions to select a number of lines to be played in each game or each game round of the game. In this game, it is typical for the player's entitlement to be affected by the amount they wager and selections they make (e.g. the nature of the wager). In the embodiment, the player's entitlement (e.g. the value of any bonus prize or jackpot) from the bonus game is affected by the amount they wager in the base game.

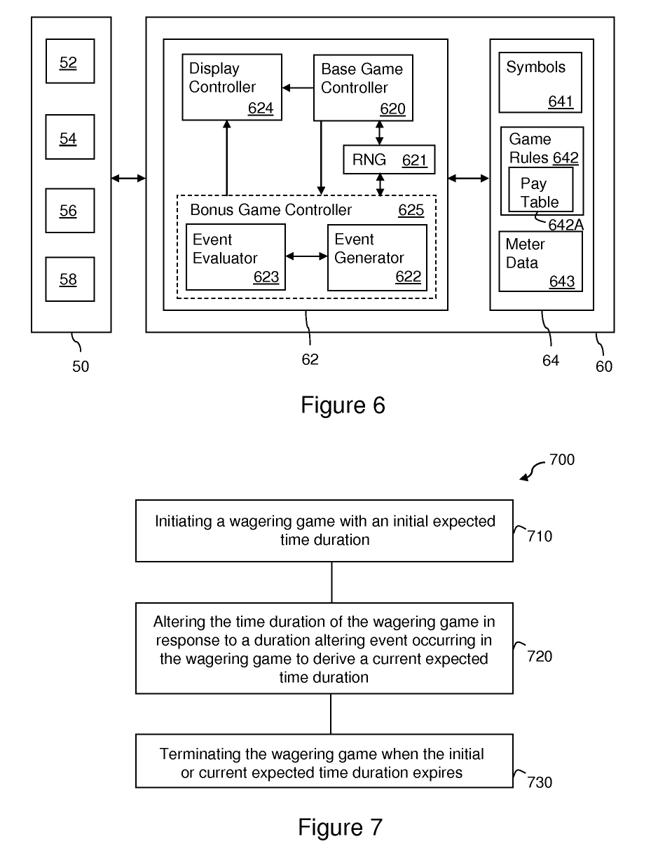

As described above, the wagering game has an initial expected time duration at which the wagering game will terminate if no time duration altering events occur in the wagering game. If time duration altering events do occur in the wagering game, a current expected time duration of the wagering game is derived. In FIG. 6, the processor 62 of the game controller 60 is shown implementing a number of modules based on program code and data stored in memory 64 to conduct both the base game and the wagering game. The modules are adapted to initiate the wagering game, based on the inputted instructions and wager, to generate and evaluate time duration altering events occurring in the wagering game to alter the time duration of the game, and to terminate the wagering game at the expiry of the initial or derived expected time duration. Persons skilled in the art will appreciate that several of the modules could be implemented in some other way; for example, by a dedicated circuit, or on a server remote from the game controller 60.

In the embodiment shown in FIG. 6, the modules of the game controller 60 include a base game controller 620 which operates in response to the player's operation of game play mechanism 56 to initiate a play of a base game to generate base game outcomes. In the example of a spinning reel type game, the player operates the game play mechanism 56 to input a wager and a number of lines to be played in each game. In response, a game outcome is generated by the base game controller 620 by selecting symbols from a set of symbols specified by symbol data 641 using random number generator 621. The selected symbols are advised to the display controller 624 which causes them to be displayed on display 54 at designated symbol display positions. In addition, the symbols 641 for the base game may be displayed in symbol display positions arranged in columns, generally representing reels, and the symbols 641 may include designated symbols to indicate that the bonus game is triggered (e.g. wild symbols). For example, the game controller 620 selects symbols from a plurality of symbol sets stored corresponding to respective ones of a plurality of spinning reels. The display controller 624 is subsequently advised of these symbols and displays them in symbol display positions such that a player selected line includes one symbol display position from each column.

In the embodiment, the base game controller 620 generates a game outcome in the base game corresponding to a trigger event to initiate the wagering game, such as selecting wild symbols to be displayed in designated symbol display positions. This trigger event is communicated to a bonus game controller 625 and, in response, the bonus game controller 625 operates to conduct the wagering game as a bonus game from the base game. The bonus game controller 625 includes an event generator 622, which operates in response to the trigger event, to initiate the wagering game and to generate time duration altering events which are be evaluated by an event evaluator 623. The event generator 622 generates these time duration altering events based on game rules 642 and using the random number generator 621. For example, the likelihood of the occurrence of the events may be allocated and stored in the game rules 642 and accordingly employed by the event generator 622. Also allocated and stored in the game rules 642 is the initial time duration of the game expected by the player. In an example, the expected time duration, initial or otherwise, may be displayed visually to the player (e.g. via a displayed clock) so that the player is aware of the duration of time remaining before the game expires.

The time duration altering events may also be displayed visually to the player and accordingly symbols 641 representing the time duration altering events are advised to the display controller 624 which causes them to be displayed on the display 54. In an example, the display controller 624 displays an object moving across the display 54 in a predefined path representing the expected duration of time of the wagering game. The object may then strike symbols, which represent an alteration to the remaining duration of the game, generated by the event generator 622. These symbols are advised to the display controller 624 to be displayed as lying on the predefined path.

In the embodiment, the event generator 622 generates truncate events to alter the time duration by truncating the time duration of the wagering game and extend events to extend the time duration of the wagering game. The event evaluator 623 evaluates the occurrence of these generated events and either extends or truncates the initial or current expected time duration of the game accordingly. It will be appreciated by those persons skilled in the art that other events may be generated; for example, the event generator 622 may generate events which do not affect the time duration of the wagering game.

The extending and truncating durations of time may also be allocated and stored in the game rules 642 along with the initial expected time duration if no truncate or extend events occur in the game. It will also be appreciated by those persons skilled in the art that a number of different truncating and extending durations may be allocated and stored in the game rules 642 along with various initial expected time durations for the wagering game, such as having various initial time durations based on the wager. Furthermore, a maximum time duration of the wagering game that the wagering game can be extended to may also be allocated and stored in the game rules 642. For example, the maximum time duration of the wagering game, from initiation to termination, is allocated as thirty seconds.

In the embodiment, a prize may be awarded to the player when the time duration expires and the game terminates. The game evaluator 623 determines and allocates a value (i.e. quantum) of the prize to be awarded based on the allocated initial or derived current expected time duration of the wagering game and this value may be displayed to the player on the display 54 via the display controller 624. At termination of the wagering game the game evaluator 623 determines the value of the prize and forwards the value to a win meter. Generally, the value of the prize is proportional to the elapsed time duration of the game from initiation to termination however it is envisaged that other game rules may be employed to determine the value of the prize, such as awarding a highest prize value to a particular time duration, e.g. thirteen seconds. In addition, the value of the prize may be affected by the amount wagered in the base game (e.g. the value of the prize is multiplied by the number of credits bet per selected line in the base game). In any case, data indicative of the value of the prize is accumulated from the event evaluator 623 to a win meter and stored as meter data 643 to be awarded to the player at termination of the game. Generally, the value of the prize is reset once it is awarded and, at termination of the game, credits are transferred to a credit meter in the meter data 643.

In an alternative embodiment, the wagering game is played independent of a base game and in this case the value of the prize is affected by the elapsed time duration, as above, and an amount wagered in the wagering game. In this case, the wagering game is initiated by the event generator 622 in response to the player inputting instructions using the game play mechanism 56 and a wager for the game.

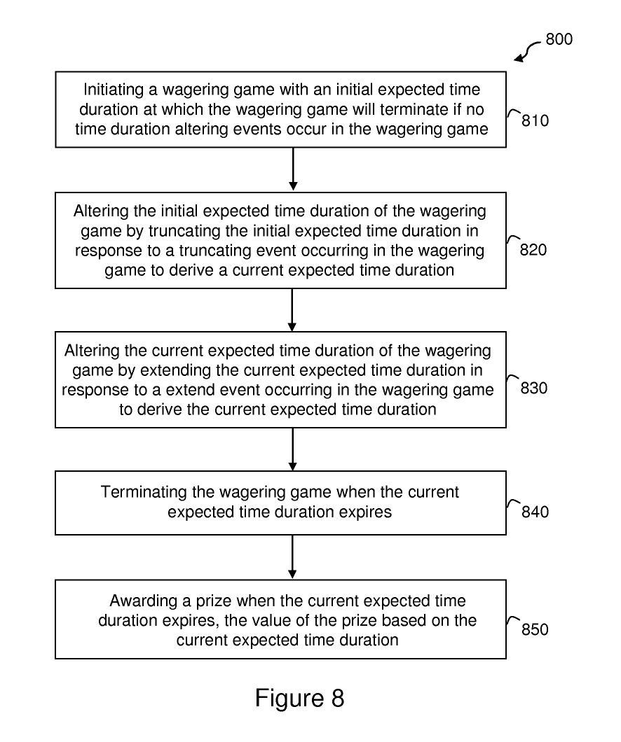

FIGS. 7-8 are flow diagrams representative of example machine readable instructions that can be executed to implement one or more of the example systems shown and described herein and/or portions of one or more of those systems. The example process(es) of FIGS. 7-8 can be performed using a processor, a controller and/or any other suitable processing device, such as the game controller 60 and/or other component of system 10. For example, the example process(es) of FIGS. 7-8 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIGS. 7-8 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIGS. 7-8 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIGS. 7-8 can be implemented manually or as any combination(s) of any of the foregoing techniques, for example, any combination of firmware, software, discrete logic and/or hardware. Further, although the example process(es) of FIGS. 7-8 are described with reference to the flow diagram of FIGS. 7-8, other methods of implementing the process(es) of FIGS. 7-8 can be employed. For example, the order of execution of the blocks can be changed, and/or some of the blocks described can be changed, eliminated, sub-divided, or combined. Additionally, any or all of the example process(es) of FIGS. 7-8 can be performed sequentially and/or in parallel by, for example, separate processing threads, processors, devices, discrete logic, circuits, etc.

An example of a wagering game employing the above method is described with reference to FIG. 8. The example 800 includes first initiating 810 a wagering game with an initial expected time duration (e.g. ten seconds) and subsequently altering 820 this initial time duration by truncating it (e.g. truncating by an allocated two seconds) in response to a truncate event occurring in the wagering game to derive a current expected time duration. Thus, in an example, if at the five second mark of the wagering game the two second truncate event is generated by the event generator 622, the event evaluator 623 will subsequently derive a current expected time duration of three seconds before the game is to be terminated.

The example 800 further includes altering 830 the current expected time duration by extending the current time duration (e.g. extending by an allocated five seconds) in response to an extend event occurring in the wagering game to derive the current expected time duration. In the example, if the wagering game is currently at two seconds before termination and a five second extend event is generated by the event generator 622, the event evaluator 623 will subsequently derive the current expected time duration to be seven seconds before the game is to be terminated. After this time duration expires, the example 800 includes terminating 840 the wagering game and subsequently awarding 850 a prize having a value based on the derived current expected time duration (e.g. eleven seconds) to the player.

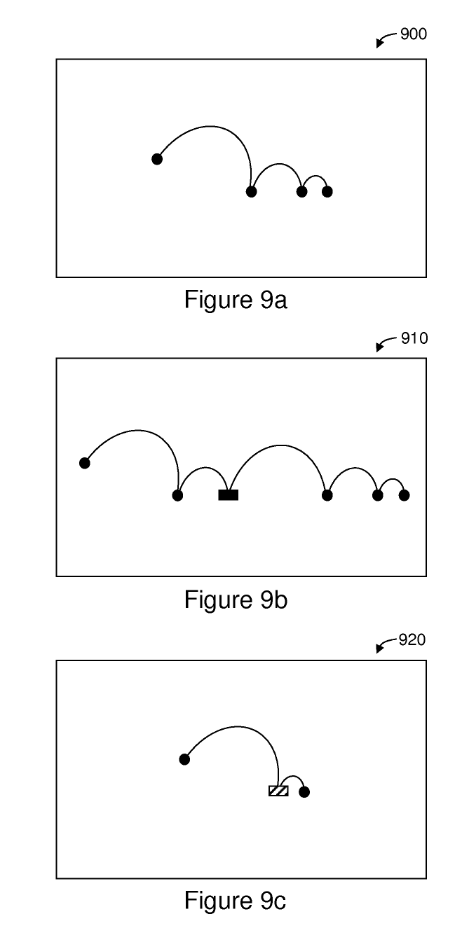

Further examples of wagering games employing the above described method of gaming can be seen in the exemplary displays illustrated in FIGS. 9a to 9c. FIGS. 9a to 9c show displays of wagering games at termination.

FIG. 9a shows a display 900 where the initial expected time duration expired as no time duration altering events occurred in the game. With reference to FIG. 6 also, the display 900 of the wagering game was displayed on the display 54 and the display of an object travelling across the display 54 was controlled by the display controller 624. At initiation of the wagering game, the object was displayed to the player in the form of a bouncing ball which travelled across the display 54 for the initial expected time duration with a displayed rate of travel and distance of travel which reduced iteratively until reaching a threshold value at expiry of the initial expected time duration. That is, the ball bounced at an iteratively slower rate and distance of travel with each successive bounce until reaching a threshold bounce height where the game was terminated. It can be seen that with each successive bounce the rate and distance of travel of the ball reduced by 50%. In addition, each bounce of the ball represented a unit of time duration, e.g. one second, and thus in the wagering game shown on the display 900 the initial expected time duration of the wagering game was three seconds.

FIG. 9b shows a display 910 of a wagering game with an initial time duration of three seconds and where on the second bounce of the ball, e.g. at two seconds, an extend event (having an allocated extending duration of two seconds) was generated by the event generator 622 and it can be seen that the expected bounce of the ball increased by 50%. Thus, the event evaluator 623 derived the current expected time duration as three seconds and advised to the display controller 624 that the rate and distance of travel of the ball was to increase by 50% upon occurrence of the extend event. In the wagering game shown on the display 910, the extend event extended the duration of the wagering game by two seconds as no further events occurred.

FIG. 9c shows a display 920 of the wagering game which also had an initial expected time duration of three seconds at which the wagering game was to be terminated but on the first bounce of the ball, i.e. at one second, a truncate event was generated by the event generator 622 with an allocated truncation duration of one second. It can be seen that the expected bounce of the ball reduced by a further 50% than would be the case if no time altering event occurred. Thus, the event evaluator 623 has derived the current expected time duration to be one second and advised to the display controller 624 that the rate and distance of travel of the ball was to decrease by the further 50% upon occurrence of the truncate event. In the wagering game shown on the display 920, the truncate event truncated the duration of the wagering game by one second as no further events occurred.

Referring back to FIG. 7, a method of gaming as described above is summarised. The method 700 includes initiating 710 a wagering game with an initial expected time duration, altering 720 the time duration of the wagering game in response to a duration altering event occurring in the wagering game to derive a current expected time duration of the game, and terminating 730 the wagering game when the initial or current expected time duration expires.

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context indicates otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

One or more of the components of the systems and/or blocks of the methods described above may be implemented alone or in combination in hardware, firmware, and/or as a set of instructions in software, for example. Certain embodiments may be provided as a set of instructions residing on a computer-readable medium, such as a memory, hard disk, DVD, Blu-ray, or CD, for execution on a general purpose computer or other processing device. Certain embodiments of the present invention may omit one or more of the method blocks and/or perform the blocks in a different order than the order listed. For example, some blocks may not be performed in certain embodiments of the present invention. As a further example, certain blocks may be performed in a different temporal order, including simultaneously, than listed above.

Certain examples include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM, Blu-ray, or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples can be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples can also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of gaming comprising:
initiating a wagering game comprising an initial expected time duration at which the wagering game will terminate if no time duration altering events occur in the wagering game;
altering the time duration of the wagering game in response to a duration altering event occurring in the wagering game to derive a current expected time duration; and
terminating the wagering game when the initial or current expected time duration expires.

2. A method as claimed in claim 1, further comprising altering the initial or current expected time duration of the wagering game by truncating the initial or current expected time duration in response to a truncate event occurring in the wagering game.

3. A method as claimed in claim 1, further comprising altering the initial or current expected time duration of the wagering game by extending the initial or current expected time duration in response to a extend event occurring in the wagering game.

4. A method as claimed in claim 2, further comprising allocating a truncating duration to truncate the initial or current expected time duration of the wagering game thereby in response to the truncate event occurring in the wagering game.

5. A method as claimed in claim 3, further comprising allocating an extending duration to extend the initial or current expected time duration of the wagering game thereby in response to the extend event occurring in the wagering game.

6. A method as claimed in claim 5, further comprising allocating a maximum time duration for the current expected time duration of the wagering game.

7. A method as claimed in claim 1, further comprising awarding a prize to a player of the wagering game when the initial or current expected time duration expires.

8. A method as claimed in claim 7, further comprising allocating a value of the prize based on the initial or current expected time duration of the wagering game.

9. A method as claimed in claim 1, wherein the wagering game is a bonus game.

10. A method as claimed in claim 1, further comprising initiating the wagering game by displaying an object to a player of the wagering game on a display, whereby the object travels across the display for the initial or current expected time duration with a displayed rate of travel and distance of travel which reduces iteratively until reaching a threshold value at expiry of the initial or current expected time duration.

11. A method as claimed in claim 10, further comprising altering the displayed rate of travel and distance of travel by further reducing the displayed rate of travel and distance of travel of the object across the display thereby truncating the initial or current expected time duration in response to a truncate event occurring in the wagering game.

12. A method as claimed in claim 10, further comprising altering the displayed rate of travel and distance of travel by extending the reducing displayed rate of travel and distance of travel of the object across the display thereby extending the initial or current expected time duration in response to an extend event occurring in the wagering game.

13. A game controller arranged to:
initiate a wagering game comprising an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

14. A gaming system comprising:
a display for displaying a wagering game to a player; and
a game controller arranged to:
initiate a wagering game comprising an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

15. A gaming system comprising:
a plurality of gaming devices; and
a game controller in data communication with the plurality of gaming devices, the game controller arranged to:
initiate a wagering game comprising an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

16. A gaming system comprising:
at least one gaming device comprising a cabinet, a display mounted within the cabinet arranged to display a wagering game to a player, and a game play mechanism mounted to the cabinet incorporating at least one input device, the game play mechanism operable by the player to place wagers in the wagering game, and a game controller disposed within the cabinet comprising a processor and a memory storing game control instructions which enable the game controller to operate, the game controller arranged to:
initiate the wagering game comprising an initial expected time duration at which the wagering game will terminate if no time duration altering events occur in the wagering game;
alter the time duration of the wagering game in response to a duration altering event occurring in the wagering game to derive a current expected time duration; and
terminate the wagering game when the initial or current expected time duration expires.

17. A gaming system comprising:
means for initiating a wagering game comprising an initial expected time duration at which the wagering game will terminate if no time duration altering events occur in the wagering game;
means for altering the time duration of the wagering game in response to a duration altering event occurring in the wagering game to derive a current expected time duration; and
means for terminating the wagering game when the initial or current expected time duration expires.

18. A computer readable medium comprising computer program code which, when executed, is to implement a method of gaming comprising:
initiating a wagering game comprising an initial expected time duration at which the wagering game will terminate if no time duration altering events occur in the wagering game;
altering the time duration of the wagering game in response to a duration altering event occurring in the wagering game to derive a current expected time duration; and
terminating the wagering game when the initial or current expected time duration expires.
